(19) United States
(12) Patent Application Publication
(10) Pub. No.: US 2025/0137577 A1
(43) Pub. Date: May 1, 2025

(54) TRIPOD WITH AN ADJUSTABLE ANGLE

(71) Applicant: TILTA INC., Burbank, CA (US)

(72) Inventors: Jingkai CAO, Shenzhen (CN); Wenping ZENG, Shenzhen (CN); Kefeng ZHOU, Shenzhen (CN)

(21) Appl. No.: 18/927,464

(22) Filed: Oct. 25, 2024

(30) Foreign Application Priority Data
Oct. 31, 2023 (CN) 2023229452020

(51) Int. Cl. F16M 11/24; F16M 11/06

(52) U.S. Cl. CPC F16M 11/242; F16M 11/06; F16M 2200/021

(57) ABSTRACT

The present disclosure provides a tripod with an adjustable angle. The tripod includes a tripod body with a limiting surface, support legs equipped with a movable rotation-limiting assembly that interacts with the limiting surface, and a rotational structure. The tripod body and support legs are rotationally connected via the rotational structure. In a first position, the rotation-limiting assembly disengages from the limiting surface, allowing the support legs to rotate relative to the tripod body. In a second position, the rotation-limiting assembly locks onto the limiting surface, securing the support legs to the tripod body. The rotational structure works in coordination with the limiting surface, limiting components, a button mechanism, and first and second reset mechanisms to enable one-touch unlocking and automatic locking of the tripod, enhancing operational convenience.

### CROSS-REFERENCE TO RELATED APPLICATIONS

The present application for patent claims priority to and the benefit of pending Chinese Application No. 2023229452020, filed Oct. 31, 2023, and hereby expressly incorporated by reference herein as if fully set forth below in its entirety and for all applicable purposes.

### TECHNICAL FIELD

The present disclosure belongs to the technical field of photography auxiliary tools, particularly involving a tripod with an adjustable angle.

### INTRODUCTION

In the operation of cameras or other photographic equipment, tripods or tripod heads are frequently used to enhance stability. However, conventional tripods generally lack convenient mechanisms for adjusting the support angle, making them less user-friendly.

### BRIEF SUMMARY

The present disclosure provides a tripod with an easily adjustable angle, simplifying the adjustment of support angles when using the tripod.

The technical solution disclosed by the present disclosure for achieving the above purpose is as follows:

The present disclosure discloses a tripod with an adjustable angle, which includes:

a tripod body with a limiting surface;
support legs equipped with a movable rotation-limiting assembly that interacts

with the limiting surface; and

a rotational structure. The tripod body and support legs are rotationally connected via the rotational structure. In a first position, the rotation-limiting assembly disengages from the limiting surface, allowing the support legs to rotate relative to the tripod body.

In a second position, the rotation-limiting assembly locks onto the limiting surface, securing the support legs to the tripod body.

Furthermore, the rotational structure comprises a rotating head on the tripod body, a rotating base at the support legs' top, and a rotating shaft connecting the rotating head and rotating base.

Furthermore, the rotation-limiting assembly includes limiting components. A first movable groove is provided on the rotating base, and the limiting surface is located at the rotating head's end. The limiting component's first end is movably positioned within the first movable groove, while the limiting component's second end interacts with the limiting surface. When the limiting component moves to the first position in the first movable groove, the limiting component's second end disengages from the limiting surface; when the limiting component moves to the second position relative to the first movable groove, the limiting component's second end locks onto the limiting surface. In the support state, the limiting component locks the rotating head to the rotating base, ensuring stability.

Furthermore, multiple limiting surfaces are arranged around the rotating shaft on the rotating head. The limiting component interacts with multiple limiting surfaces on the rotating head, each corresponding to a different support angle. This enables the support legs to be adjusted to various angles as needed.

Furthermore, the rotation-limiting assembly further includes an unlocking button. A second movable groove is provided on the rotating base, communicating with the first movable groove. The unlocking button is movably arranged within the second groove. A first engaging slope is provided on the limiting component, and a second engaging slope is provided on the unlocking button, with the first engaging slope and the second engaging slope fitting together. In this application, when the unlock button is pressed, it moves forward within the second movable groove. This movement causes the second engaging slope to press against the first engaging slope, driving the limiting component to shift within the first movable groove, thus disengaging the limiting surface and unlocking the rotating head from the rotating base. This allows free rotation between the rotating head and the base, facilitating easy adjustment of the support angle.

Furthermore, the rotation-limiting assembly further includes a first reset mechanism. A first end of the first reset mechanism presses against the limiting component at one end away from the limiting surface, while a second end presses against the first movable groove's bottom wall. In this application, when the limiting component disengages from the limiting surface due to pressure from the unlock button, releasing the unlock button in the unlocked state allows the first reset mechanism to push the limiting component back toward the limiting surface. This re-engages the limiting component with the limiting surface, locking the rotating head to the rotating base once again. The unlocking operation is simplified, as the user only needs to hold the support leg with one hand and press the unlock button while rotating. Once the desired angle is achieved, releasing the unlock button allows the limiting component to automatically engage with the corresponding limiting surface, making the locking process straightforward and convenient.

Furthermore, the rotation-limiting assembly further includes a second reset mechanism. The unlocking button includes a pressing part, and the second reset mechanism is arranged within the second movable groove, with a first end pressing against the pressing part and a second end pressing against the second groove's side wall. In this application, upon releasing the unlock button in the unlocked state, the unlock button resets under the force of the second reset mechanism, which relieves the pressure on the limiting component. The limiting component is then reset by the first reset mechanism.

Furthermore, both sides of the limiting component are in contact with the first movable groove's side wall, allowing the limiting component to move towards or away from the limiting surface when subjected to force from the unlocking button or the first reset mechanism to prevent misalignment between the limiting component and the limiting surface during movement

Furthermore, the limiting component is provided with a movable hole. The unlocking button includes an unlocking part positioned relative to the pressing part, which penetrates the movable hole. A notch is provided on the unlocking part, pressing against the movable hole's side wall. The first engaging slope is set on the movable hole's side wall, while the second engaging slope is set on the notch. In this application, the fit between the notch and the movable hole provides a more stable and close connection between the limiting component and the unlock button.

Furthermore, the rotating base is further equipped with a guiding limiting component. The unlocking part includes a guiding limiting hole aligned with the second movable groove's direction, and the guiding limiting component's end is movably arranged within the guiding limiting hole. In this application, when the unlock button moves within the second movable groove, the lower end of the guiding limiting component moves within the guiding limiting hole, providing directional guidance, playing a position-limiting role, and preventing positional deviation of the unlock button.

Furthermore, the second movable groove is composed of a first and second groove body, which are interconnected. The first groove body has a larger cross-sectional area than the second groove body, creating a stepped surface at the junction of the groove bodies. The end of the second reset mechanism away from the pressing part presses against this stepped surface. The cross-sectional area referred to here is perpendicular to the movement direction of the unlock button.

Compared to prior technology, the object of the present disclosure lies in:

Its ability to connect the support legs to the tripod body through the rotational structure, facilitating easy adjustment of the support angle. Furthermore, the rotational structure works in coordination with the limiting surface, limiting components, a button mechanism, and first and second reset mechanisms to enable one-touch unlocking and automatic locking of the tripod, enhancing operational convenience.

### BRIEF DESCRIPTION OF THE DRAWINGS

FIG. 1 is a diagram illustrating a first view of an exemplary tripod with a tripod head according to some aspects of the disclosure.

FIG. 2 is a diagram illustrating a second view of the tripod according to some aspects of the disclosure.

FIG. 3 is a diagram illustrating an exploded view of one set of rotational structures according to some aspects of the disclosure.

FIG. 4 is a diagram illustrating a top view of the rotational structures according to some aspects of the disclosure.

FIG. 5 is a diagram illustrating a sectional view at the plane line A-A in FIG. 4.

FIG. 6 is a diagram illustrating an assembly of a limiting component and an unlock button according to some aspects of the disclosure.

FIG. 7 is a diagram of the limiting component according to some aspects of the disclosure.

FIG. 8 is a diagram of the unlock button according to some aspects of the disclosure.

### REFERENCE NUMBERS OF ELEMENTS

100—Tripod; 200—Tripod head;
1—Tripod body;
2—Support leg;
3—Rotational structure; 31—Rotating head; 311—Limiting surface; 32—Rotating base; 321—First movable groove; 322—Second movable groove; 3221—First groove body; 3222—Second groove body; 3223—Stepped surface; 33—Rotating shaft;
4—Rotation-limiting assembly; 41—Limiting component; 411—First engaging slope; 412—Movable hole; 42—Unlock button; 421—Second engaging slope; 422—Pressing part; 423—Notch; 424—Guiding limiting hole; 425—Unlocking part; 43—First reset mechanism; 44—Second reset mechanism; 45—Guiding limiting component;
A—First end; B—Second end.

### DETAILED DESCRIPTION

To elucidate the purpose, technical solution, and features of the present disclosure, a detailed description is presented in conjunction with the accompanying drawings and exemplary embodiments. It is important to note that the specific embodiments outlined herein are intended solely for explanatory purposes and do not serve to limit the scope of the present disclosure.

The technical solution proposed by this disclosure for achieving the above purpose is as follows.

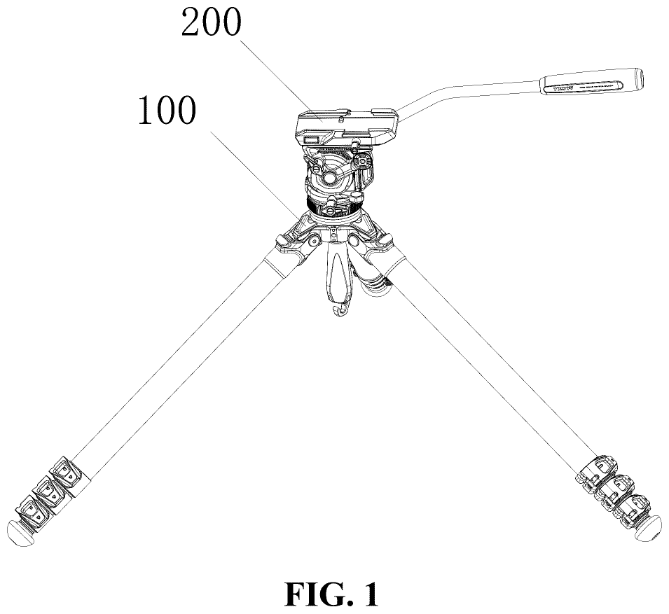

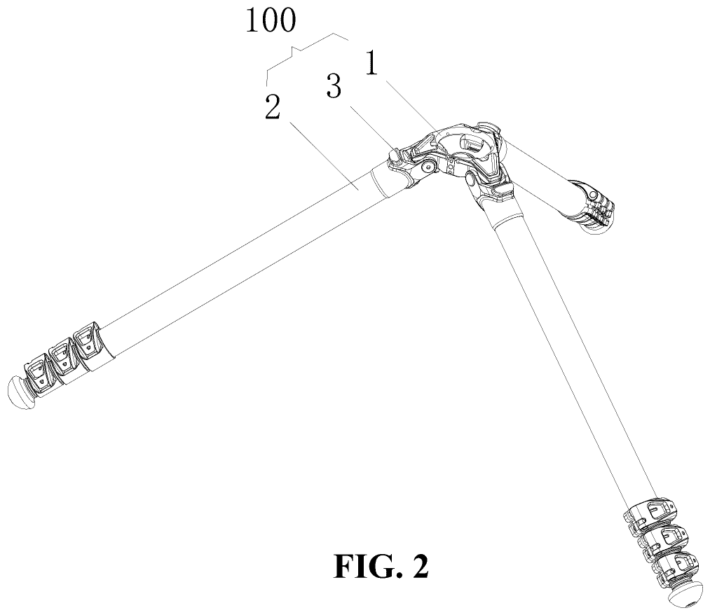

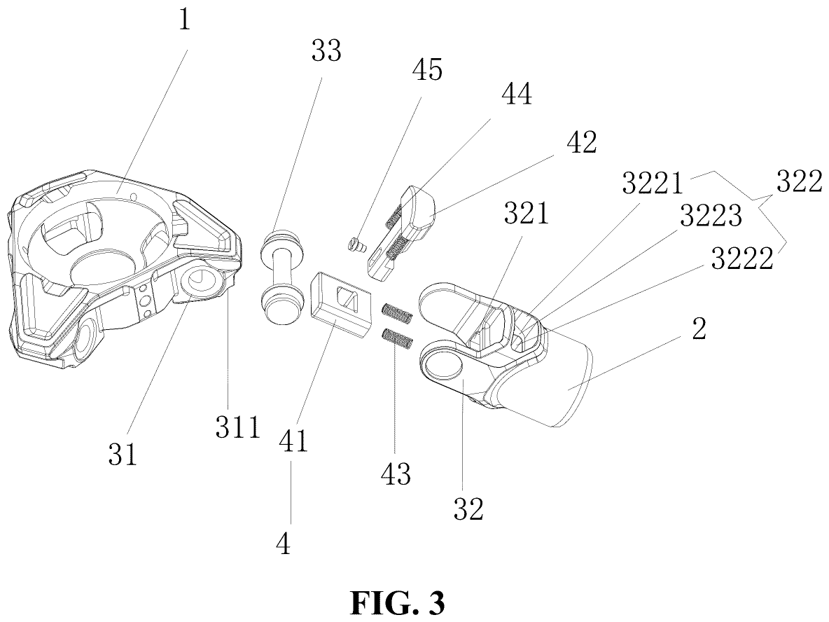

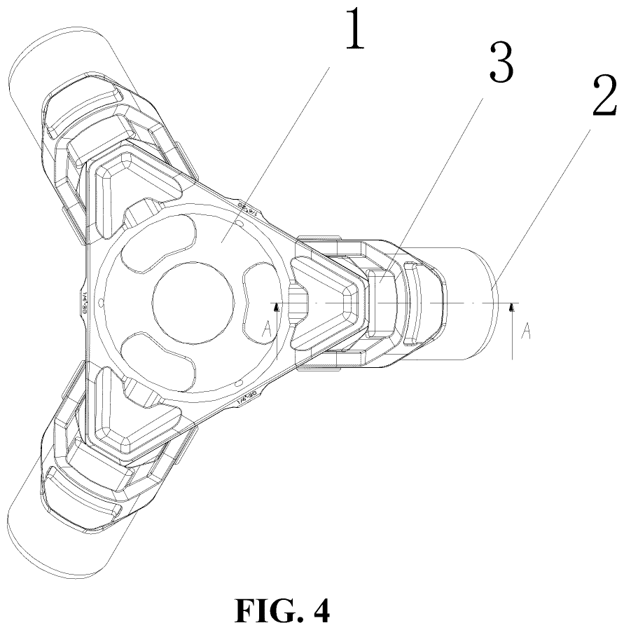

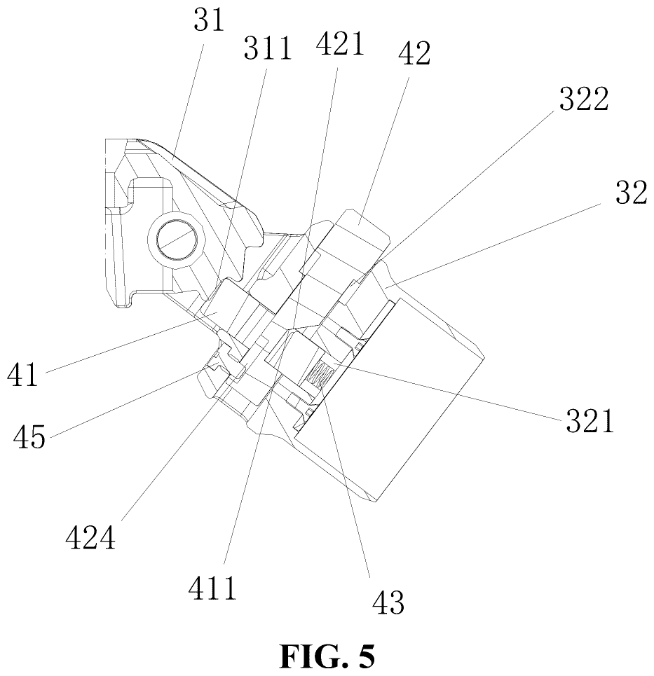

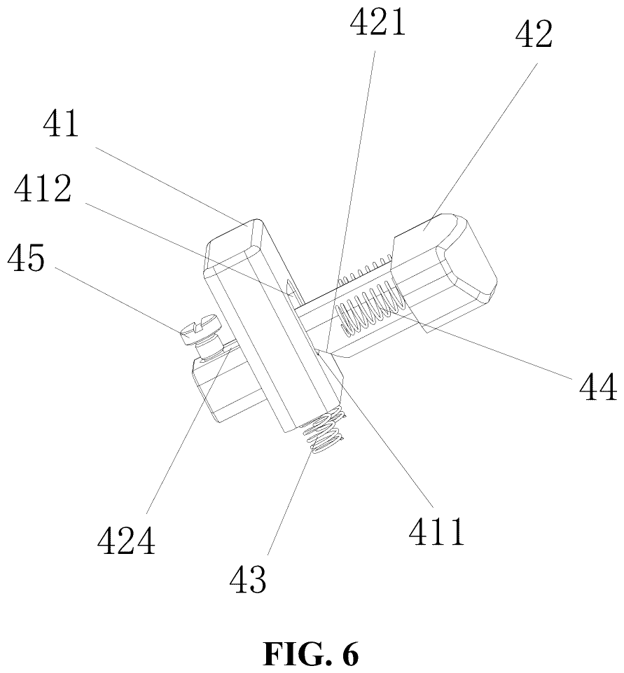

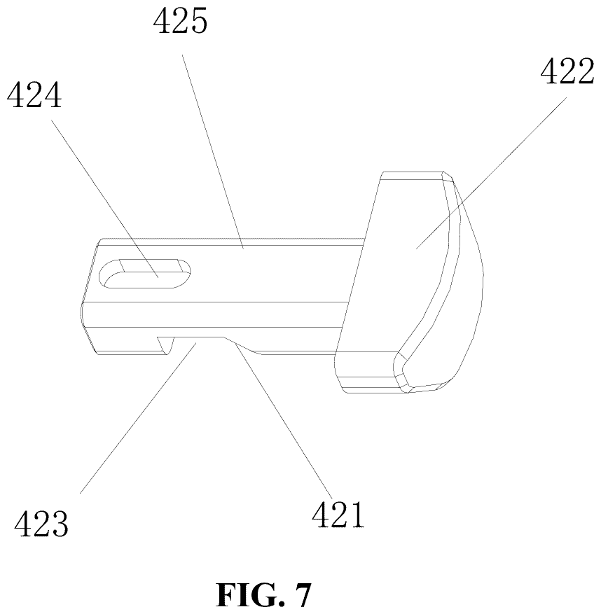

Referring to FIGS. 1-8, the present disclosure discloses a tripod 100 with an adjustable angle, including: a tripod body 1 with a limiting surface 311; two more support legs 2, each equipped with a movable rotation-limiting assembly 4 that interacts with the limiting surface 311; and a rotational structure 3.

The tripod body and support legs are rotationally connected via the rotational structure. In a first position, the rotation-limiting assembly disengages from the limiting surface, enabling the support legs to rotate relative to the tripod body. In a second position, the rotation-limiting assembly locks onto the limiting surface, securing the support legs to the tripod body.

In this disclosure, a camera can be attached to the tripod body 1 via a tripod head 200. The rotational structure 3 enables the support legs 2 to rotate relative to the tripod body 1, enabling both the deployment and retraction of the support legs 2, facilitating angle adjustments, and enhancing usability.

In some aspects, the tripod can employ three support legs 2, each connected to the tripod body 1 through a corresponding rotational structure 3.

In some aspects, the rotational structure 3 includes a rotating head 31 on the tripod body 1, a rotating base 32 at the top end of the support legs 2, and a rotating shaft 33 connecting the rotating head 31 with the rotating base 32.

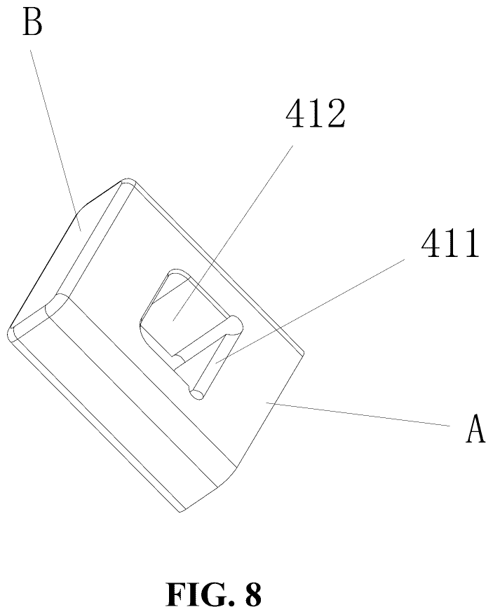

In some aspects, the rotation-limiting assembly 4 includes limiting components 41. A first movable groove 321 is provided on the rotating base 32, and the limiting surface 311 is located at an end of the rotating head 31. A first end A (see FIG. 8) of the limiting component 41 is movably positioned within the first movable groove 321, while a second end B (see FIG. 8) of the limiting component 41 interacts with the limiting surface 311. When the limiting component 41 moves to the first position in the first movable groove 321, the limiting component's second end B disengages from the limiting surface 311; when the limiting component 41 moves to the second position relative to the first movable groove 321, the second end B of the limiting component 41 locks onto the limiting surface 311. In this example, in the support state, the limiting component 41 locks the rotating head 31 to the rotating base 32, ensuring stability.

In some aspects, three limiting surfaces 311 are arranged around the rotating shaft 33 on the rotating head 31. The limiting component 41 interacts with the three limiting surfaces on the rotating head 31, each corresponding to a different support angle. Three limiting surfaces 311 enable the support legs 2 to be adjusted to three angles as needed.

In some aspects, the rotation-limiting assembly 4 includes an unlocking button 42. A second movable groove 322 is provided on the rotating base 32, communicating with the first movable groove 321. The unlocking button 42 is movably arranged within the second groove 322. A first engaging slope 411 is provided on the limiting component 41, and a second engaging slope 421 is provided on the unlocking button 42, with the first engaging slope 411 and the second engaging slope 421 fitting together. In some aspects, when the unlock button 42 is pressed, it moves forward within the second movable groove 322. This movement causes the second engaging slope 421 to press against the first engaging slope 411, driving the limiting component 41 to shift within the first movable groove 321, thus disengaging the limiting surface and unlocking the rotating head 31 from the rotating base 32. This enables free rotation between the rotating head 31 and the rotating base 32, facilitating easy adjustment of the support angle.

In some aspects, the rotation-limiting assembly 4 includes a first reset mechanism 43. A first end of the first reset mechanism 43 presses against the limiting component 41 at one end away from the limiting surface 311, while a second end presses against a bottom wall of the first movable groove 321. In some aspects, when the limiting component 41 disengages from the limiting surface 311 due to pressure (e.g., pressing down into the second movable groove 322) from the unlock button 42, releasing the unlock button 42 in the unlocked state allows the first reset mechanism 43 to push the limiting component 41 back toward the limiting surface 311. This re-engages the limiting component with the limiting surface 311, locking the rotating head 31 to the rotating base 32 once again. The unlocking operation is simplified, as the user only needs to hold the support leg 2 with one hand and press the unlock button 42 while rotating. Once the desired angle is achieved, releasing the unlock button 42 allows the limiting component 41 to automatically engage with the corresponding limiting surface 311, making the locking process straightforward and convenient.

In some aspects, the rotation-limiting assembly 4 includes a second reset mechanism 44. The unlocking button 42 includes a pressing part 422, and the second reset mechanism 44 is arranged within the second movable groove 322, with a first end pressing against the pressing part 422 and a second end pressing against a side wall of the second groove 322. In this example, upon releasing the unlock button 42 in the unlocked state, the unlock button resets under the force of the second reset mechanism 44, which relieves the pressure on the limiting component 41. The limiting component 41 is then reset by the first reset mechanism 43.

In some aspects, both the first and second reset mechanisms in this embodiment can be spring-based or the like, utilizing the elastic extension and compression of the springs to reset the limiting component and the unlock button.

Moreover, both sides (opposite sides) of the limiting component 41 are in contact with the respective sidewalls of the first movable groove 321, ensuring that the limiting component 41 can only move toward or away from the limiting surface under the force of the unlock button 42 or the first reset mechanism 43, thereby preventing misalignment between the limiting component 41 and the limiting surface during operation.

In some aspects, the limiting component 41 is provided with a movable hole 412. The unlocking button 42 includes an unlocking part 425 positioned relative to the pressing part 422, which penetrates the movable hole 412. A notch 423 is provided on the unlocking part 425, pressing against a side wall of the movable hole 412. The first engaging slope 411 is set on the side wall of the movable hole 412, while the second engaging slope 421 is set on the notch 423. In this example, the fit between the notch 423 and the movable hole 412 provides a more stable and close connection between the limiting component 41 and the unlock button 42.

In some aspects, a guiding limiting component 45 is connected to the rotating base 32. The unlocking part 425 includes a guiding limiting hole 424 aligned with the direction of the second movable groove 322, and an end of the guiding limiting component 45 is movably arranged within the guiding limiting hole 424. In this example, when the unlock button 42 moves within the second movable groove 322, the lower end of the guiding limiting component 45 moves within the guiding limiting hole 424, providing directional guidance and preventing positional deviation of the unlock button 42.

In some aspects, the second movable groove 322 includes a first groove body 3221 and a second groove body 3222, which are interconnected. The first groove body 3221 has a larger cross-sectional area than the second groove body 3222, creating a stepped surface 3223 at the junction of the groove bodies 3221 and 3222. The end of the second reset mechanism 44 away from the pressing part 422 presses against this stepped surface 3223. The cross-sectional area referred to here is perpendicular to the movement direction of the unlock button.

The foregoing represents only an exemplary embodiment of the present disclosure and is not intended to restrict its scope. Any modifications, equivalent replacements, and enhancements made within the spirit and principles of the present disclosure should be encompassed within the protective scope of the present disclosure.

What is claimed is:

1. A tripod with an adjustable angle, comprising:
a tripod body with a limiting surface;
a support leg, movably connected to the tripod body via a rotational structure; and
a movable rotation-limiting assembly connected to the support leg, the movable rotation-limiting assembly being configured to interact with the limiting surface to adjust an angle between the tripod body and the support leg; and
wherein in a first position, the movable rotation-limiting assembly disengages from the limiting surface, permitting the support leg to rotate relative to the tripod body; and
wherein in a second position, the movable rotation-limiting assembly engages the limiting surface, securing the support leg to the tripod body.

2. The tripod with an adjustable angle according to claim 1,
wherein in the first position, the movable rotation-limiting assembly is configured to permit manual rotation of the support leg in a first direction or in a second direction;
and
wherein in the second position, the movable rotation-limiting assembly is configured to limit manual rotation of the support leg in the second direction.

3. The tripod with an adjustable angle according to claim 1, wherein the rotational structure comprises a rotating head on the tripod body, a rotating base at a first end of the support leg, and a rotating shaft connecting the rotating head with the rotating base.

4. The tripod with an adjustable angle according to claim 3, wherein the movable rotation-limiting assembly comprises a limiting component;
a first movable groove is provided on the rotating base, and the limiting surface is located at an end of the rotating head;
a first end of the limiting component is movably positioned within the first movable groove, and a second end of the limiting component interacts with the limiting surface;
wherein the second end of the limiting component disengages from the limiting surface, in response to the limiting component moves to the first position in the first movable groove; and
wherein the second end of the limiting component locks onto the limiting surface, in response to the limiting component moves to the second position relative to the first movable groove.

5. The tripod with an adjustable angle according to claim 4, wherein a plurality of limiting surfaces are arranged around the rotating shaft on the rotating head;
wherein the limiting component moves to the first position in the first movable groove, the second end of the limiting component disengages from the plurality of limiting surfaces, in response to the limiting component moves to the first position in the first movable groove; and
wherein the limiting component moves to the second position relative to the first movable groove, the second end of the limiting component locks onto one of the plurality of limiting surfaces, in response to the limiting component moves to the second position relative to the first movable groove.

6. The tripod with an adjustable angle according to claim 4, wherein the movable rotation-limiting assembly further comprises an unlocking button;
a second movable groove is provided on the rotating base, communicating with the first movable groove;
the unlocking button is movably arranged within the second movable groove; and
a first engaging slope is provided on the limiting component, and a second engaging slope is provided on the unlocking button, with the first engaging slope being configured to cooperate with the movement of the second engaging slope.

7. The tripod with an adjustable angle according to claim 6, wherein the movable rotation-limiting assembly further comprises a first reset mechanism; and
the first reset mechanism is between the limiting component and a bottom wall of the first movable groove.

8. The tripod with an adjustable angle according to claim 7, wherein the movable rotation-limiting assembly further comprises a second reset mechanism; and
the unlocking button comprises a pressing part, and the second reset mechanism is arranged within the second movable groove, and is provided between the pressing part and a side wall of the second movable groove.

9. The tripod with an adjustable angle according to claim 6, wherein two sides of the limiting component are respectively in contact with two side walls of the first movable groove.

10. The tripod with an adjustable angle according to claim 6, wherein the limiting component is provided with a movable hole;
the unlocking button comprises an unlocking part which penetrates the movable hole;
a notch is provided on the unlocking part, pressing against a side wall of the movable hole; and
the first engaging slope is set on a side wall of the movable hole, while the second engaging slope is set on the notch.

11. The tripod with an adjustable angle according to claim 6, further comprising a guiding limiting component;
the unlocking part comprises a guiding limiting hole that coordinates with the second movable groove, and an end of the guiding limiting component is movably arranged within the guiding limiting hole.
